(19) United States
(12) Patent Application Publication
(10) Pub. No.: US 2010/0167148 A1
(43) Pub. Date: Jul. 1, 2010

(54) TEMPERATURE CONTROL SYSTEM FOR FUEL CELL

(76) Inventor: Kota Manabe, Toyota-shi (JP)

Correspondence Address: KENYON & KENYON LLP, 1500 K STREET N.W., SUITE 700, WASHINGTON, DC, 20005, US

(21) Appl. No.: 12/293,592

(22) PCT Filed: Mar. 30, 2007
(86) PCT No.: PCT/JP2007/057694

§ 371 Date: Sep. 19, 2008

(30) Foreign Application Priority Data
Apr. 10, 2006 (JP) 2006-107232

(51) Int. Cl. H01M 8/04

(52) U.S. Cl. 429/434

(57) ABSTRACT

Provided is a temperature control system which can suppress a cell voltage fluctuation even in the case of starting under a low-temperature environment. The temperature control system for a fuel cell according to the present invention circulates a heat transfer medium through the fuel cell to control the temperature of the fuel cell. The system is characterized by including circulation control means for circulating, through the fuel cell, the heat transfer medium having a flow rate larger than that for a normal operation during a low-temperature operation. According to such a constitution, the flow rate of the heat transfer medium (cooling water or the like) for low-temperature start is set to a flow rate larger than that of the heat transfer medium for normal start, so that a temperature fluctuation among cells can be suppressed even in the case of warm-up for the low-temperature start, and as a result, the cell voltage fluctuation can be suppressed.

### TECHNICAL FIELD

The present invention relates to a temperature control system for a fuel cell.

### BACKGROUND ART

A fuel cell system is known in which power is generated using the electrochemical reaction between a fuel gas including hydrogen and an oxidizing gas including oxygen. Such a fuel cell is highly efficient clean power generation means, and is hence largely expected as a driving power source for a two-wheeled vehicle, a car and the like.

However, the fuel cell has poor starting properties as compared with another power source, and a cell voltage fluctuation is generated between the ends of the fuel cell and the center thereof especially in a case where the system is started under a low-temperature environment. In general, end plates are provided on both the ends of the fuel cell in which a plurality of cells are laminated (see FIG. 9). When the system is started at a low temperature, a fuel cell 1 is warmed up by effectively using self heat generation accompanying power generation. However, end plates 3 have a thermal capacity larger than that of cells 2, so that the heat of the cells 2 at both the ends is taken by the end plates 3. As a result, there occurs a problem that a temperature gradient is generated in accordance with the positions of the cells in a stack to generate the cell voltage fluctuation.

In view of such a problem, a method is suggested in which, for example, insulating plates are arranged on the end cells of the fuel cell to suppress the temperature gradient among the cells (e.g., see Patent Document 1).

[Patent Document 1] Japanese Patent Application Laid-Open No. 2004-152052

### DISCLOSURE OF THE INVENTION

However, there is a problem that in the case of an operation (start or the like) under a low-temperature environment, end cells radiate heat to generate a larger temperature gradient in a stack. There is also a problem that in a case where the above-mentioned insulating plates are arranged, a system enlarges.

The present invention has been developed in view of the above-mentioned situation, and an object thereof is to provide a temperature control system capable of suppressing a cell voltage fluctuation even in the case of starting under the low-temperature environment.

To achieve the above problem, a temperature control system for a fuel cell according to the present invention is a temperature control system for a fuel cell which circulates a heat transfer medium through the fuel cell to control the temperature of the fuel cell, characterized by: comprising circulation control means for circulating, through the fuel cell, the heat transfer medium having a flow rate larger than that for a normal operation during a low-temperature operation.

Here, the “low temperature” is, for example, a temperature lower than ordinary temperature, a temperature around zero degree, or a temperature below the freezing point. The “flow rate larger than that for the usual operation” includes an absolute flow rate, a flow speed and a pressure. According to such a constitution, the flow rate of the heat transfer medium (cooling water or the like) for low-temperature start is set to a flow rate larger than that of the heat transfer medium for normal start, so that a temperature fluctuation among cells can be suppressed even in the case of warm-up for the low-temperature start, and as a result, the cell voltage fluctuation can be suppressed.

Here, the above constitution further comprises judgment means for detecting the temperature concerning the fuel cell to judge based on the detection result whether to start the system at the low temperature or to normally start the system during the starting of the system. The circulation control means is preferably configured to circulate, through the fuel cell, the heat transfer medium having a flow rate larger than that for the usual start during the low-temperature start.

Moreover, the constitution is preferably provided with heaters which heat the ends of the fuel cell during the low-temperature operation or a heater which heats the heat transfer medium during the low-temperature operation (see FIGS. 6 to 8). Furthermore, the flow rate of the heat transfer medium to be circulated during the low-temperature operation may be the maximum flow rate allowed by the system.

As described above, according to the present invention, a cell voltage fluctuation can be suppressed even in the case of starting under a low-temperature environment.

### BRIEF DESCRIPTION OF THE DRAWINGS

FIG. 1 is a diagram showing the main part constitution of a fuel cell system according to the present embodiment;

FIG. 2 is a diagram showing the temperature distribution of a fuel cell according to the embodiment;

FIG. 3 is a diagram showing the dependence of the IV characteristics of the fuel cell on a temperature according to the embodiment;

FIG. 4 is a diagram in which cell voltages at the temperatures are plotted in time series according to the embodiment;

FIG. 5 is a flow chart showing the operation during system start according to the embodiment;

FIG. 6 is a diagram showing an example of heater installation according to a modification;

FIG. 7 is a diagram showing another example of the heater installation according to the modification;

FIG. 8 is a diagram showing still another example of the heater installation according to the modification; and

FIG. 9 is a diagram showing the schematic constitution of the fuel cell.

### BEST MODE FOR CARRYING OUT THE INVENTION

An embodiment according to the present invention will hereinafter be described with reference to the drawings.

### A. Present Embodiment

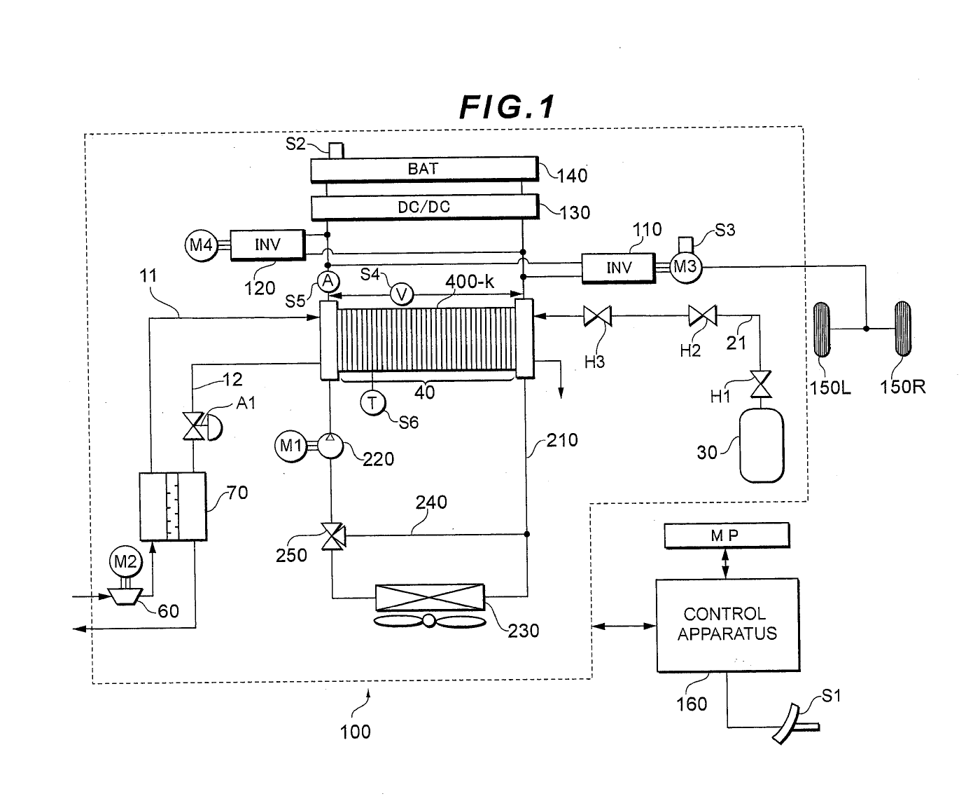

FIG. 1 is a diagram showing the main part constitution of a fuel cell system 100 according to the present embodiment. In the present embodiment, a fuel cell system to be mounted on a vehicle such as a fuel cell car (FCHV), an electric car or a hybrid car is assumed, but the present invention is applicable not only to the vehicle but also to any type of mobile body (e.g., a ship, an airplane, a robot or the like) and a stational power source.

A fuel cell 40 is means for generating power from a supplied reaction gas (a fuel gas and an oxidizing gas), and has a stack structure in which a plurality of unitary cells 400-k (1≦k≦n) each including a membrane/electrode assembly (MEA) and the like are laminated in series. Specifically, various types of fuel cells such as a solid polymer type, a phosphoric acid type and a dissolved carbonate type may be used.

A fuel gas supply source 30 is means for supplying a fuel gas such as a hydrogen gas to the fuel cell 40, and is constituted of, for example, a high-pressure hydrogen tank, a hydrogen storage tank or the like. A fuel gas supply path 21 is a gas channel for guiding the fuel gas discharged from the fuel gas supply source 30 to an anode pole of the fuel cell 40. From the upstream side of the gas channel to the downstream side thereof, valves such as a tank valve H1, a hydrogen supply valve H2 and an FC inlet valve H3 are arranged. The tank valve H1, the hydrogen supply valve H2 and the FC inlet valve H3 are shut valves for supplying (or blocking) the fuel gas to the fuel gas supply path 21 and the fuel cell 40, and are constituted of, for example, electromagnetic valves.

An air compressor 60 supplies oxygen (the oxidizing gas) taken from outside air via an air filter (not shown) to a cathode pole of the fuel cell 40. A cathode off gas is discharged from a cathode of the fuel cell 40. The cathode off gas includes an oxygen off gas subjected to the cell reaction of the fuel cell 40 and the like. This cathode off gas contains a water content formed by the cell reaction of the fuel cell 40, and hence has a highly wet state.

A humidification module 70 performs water content exchange between a lowly wet oxidizing gas flowing through an oxidizing gas supply path 11 and the highly wet cathode off gas flowing through a cathode off gas channel 12, to appropriately humidify the oxidizing gas to be supplied to the fuel cell 40. The back pressure of the oxidizing gas to be supplied to the fuel cell 40 is adjusted by a pressure adjustment valve A1 arranged around a cathode outlet of the cathode off gas channel 12.

The pressure of a part of direct-current power generated in the fuel cell 40 is lowered by a DC/DC converter 130 to charge a battery 140.

The battery 140 is a chargeable/dischargeable secondary cell, and is constituted of any type of secondary cell (e.g., a nickel hydrogen battery or the like). Needless to say, instead of the battery 140, a chargeable/dischargeable power storage unit other than the secondary cell, for example, a capacitor may be used.

A traction inverter 110 and an auxiliary device inverter 120 are PWM inverters of a pulse width modulation system, and convert, into three-phase alternate-current power, direct-current power output from the fuel cell 40 or the battery 140 in accordance with a given control instruction to supply the power to a traction motor M3 and an auxiliary device motor M4.

The traction motor M3 is a motor for driving wheels 150L, 150R, and the auxiliary device motor M4 is a motor for driving various auxiliary devices. It is to be noted that the auxiliary device motor M4 generically includes a motor M2 which drives the air compressor 60, a motor M1 which drives a cooling water pump 220 and the like.

A cooling system 200 circulates antifreeze cooling water (a heat transfer medium) or the like through the fuel cell 40 to control the temperature of the cells 400-k, and includes a cooling water circulation path 210 for circulating the cooling water through the fuel cell 40, the cooling water pump 220 for adjusting the flow rate of the cooling water, and a radiator 230 for cooling the cooling water. The cooling water circulated through the cells 400-k performs heat exchange between the water and the outside air in the radiator 230, and is cooled. Moreover, the cooling system 200 is provided with a bypass channel 240 which allows the cooling water to bypass the radiator 230. A flow rate ratio between the flow rate of the cooling water passed through the radiator 230 and the bypass flow rate of the cooling water which bypasses the radiator 230 is controlled into a desired value by adjusting the open degree of a rotary valve 250.

A control device 160 is constituted of a CPU, an ROM, an RAM and the like, and centrally controls system sections based on input sensor signals. Specifically, the control device controls the output pulse widths and the like of the inverters 110, 120 based on the sensor signals input from an accelerator pedal sensor s1 which detects an accelerator pedal open degree, an SOC sensor s2 which detects the state of charge (SOC) of the battery 140, a T/C motor rotation number detection sensor s3 which detects the rotation number of the traction motor M3, and a voltage sensor s4, current sensor s5 and temperature sensor s6 which detect the output voltage, output current and inner temperature of the fuel cell 40, respectively, and the like.

Moreover, the control device (circulation control means) 160 adjusts the flow rate of the cooling water to be circulated through the cooling water circulation path 210 based on the temperature of the fuel cell 40 during system start detected by the temperature sensor s6 (details will be described later).

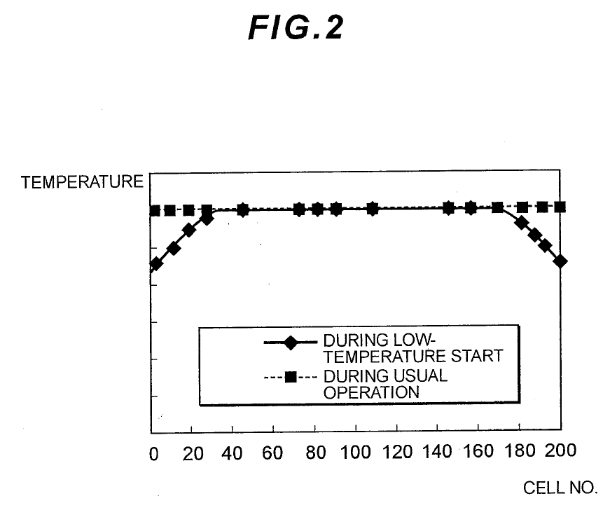

FIG. 2 is a diagram showing the temperature distribution of the fuel cell. The temperature gradient of the cell during low-temperature start is shown by a solid line, and the temperature gradient of the cell during a usual operation after the completion of warm-up is shown by a broken line. The abscissa indicates a cell number (n=200), and the ordinate indicates the temperature.

As shown in FIG. 2, the temperature of each cell is substantially constant in a usual operation state after the completion of the warm-up, whereas the temperature rise of end cells is delayed as compared with the temperature rise of central cells in a warm-up operation state during the low-temperature start (see the paragraphs of the Problem to be solved by the Invention).

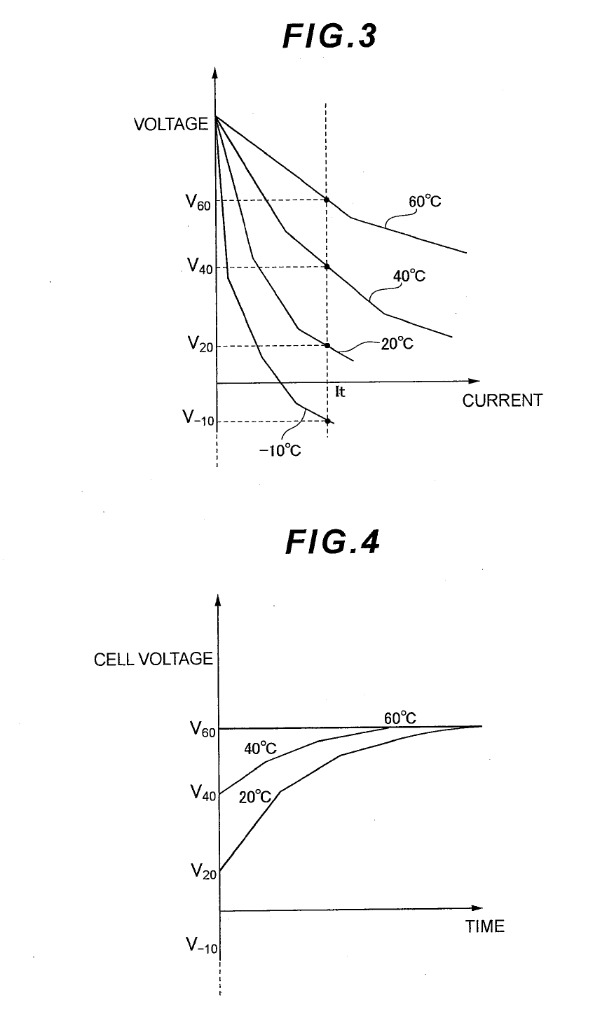

FIG. 3 is a diagram showing the dependence of the current/voltage characteristics (hereinafter referred to as the IV characteristics) of the fuel cell on the temperature, and the IV characteristics at 60° C., 40° C., 20° C. and −10° C. are shown, respectively.

As shown in FIG. 3, the IV characteristics of the fuel cell 40 have the dependence on the temperature. As the temperature lowers, the IV characteristics deteriorate. Here, the cells constituting the fuel cell 40 are connected in series, so that the same current (e.g., a current It shown in FIG. 3) flows through all the cells. In FIG. 4, cell voltages at the temperatures in a case where the current It flows are plotted in time series. As shown in FIG. 4, as the temperature lowers (the IV characteristics deteriorate), the cell voltage decreases. As extreme examples, FIGS. 3 and 4 show the IV characteristics and the cell voltage at −10° C. When the cell having such characteristics is present in the fuel cell 40, the cell voltage becomes a reverse potential, which requires a countermeasure such as current limitation or system stop. In view of such a situation, in the present embodiment, a temperature fluctuation among the cells during the low-temperature start is suppressed to suppress a cell voltage fluctuation. A specific method for suppressing the temperature fluctuation among the cells will hereinafter be described.

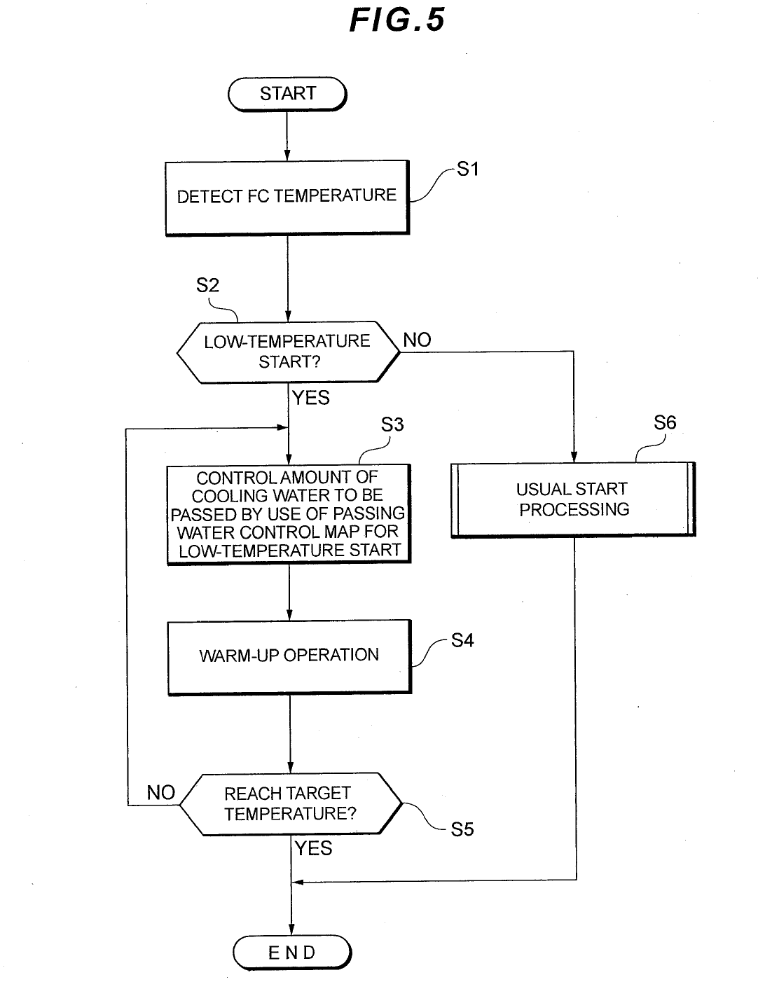

FIG. 5 is a diagram showing processing to be executed by the control device 160 during the system start.

When an ignition key is turned on and the control device 160 receives a system start command from an operating section, the control device grasps a temperature Ts of the fuel cell 40 detected by the temperature sensor s6 (step S1). It is to be noted that instead of the temperature Ts of the fuel cell 40, an outside air temperature or a cooling water temperature (a temperature concerning the fuel cell) may be used.

The control device 160 (judgment means) judges whether to perform the low-temperature start or usual start based on the detection result of the temperature Ts of the fuel cell 40. This will be described in detail. When the temperature Ts of the fuel cell 40 during the system start exceeds a preset reference temperature Tth (step S2; NO), the control device 160 advances to step S6 to perform usual start processing. On the other hand, when the temperature Ts of the fuel cell 40 during the system start is the preset reference temperature Tth or less (step S2; YES), the control device judges that the low-temperature start should be performed and advances to step S3. Examples of the reference temperature Tth include a temperature lower than ordinary temperature, a temperature around 0 degree and a temperature below the freezing point, but the temperature is arbitrarily set.

In the step S3, the control device 160 refers to a passing water control map MP for the low-temperature start stored in a memory, and adjust the flow rate of the cooling water to be circulated through the cooling system. In this passing water control map MP for the low-temperature start, the amount of the cooling water to be passed and the rotation number of the cooling water pump 220 are associated with each other and registered. An amount W1 of the water to be passed during the low-temperature start is set to a value larger than an amount Wh (<W1) of the water to be passed during the usual start. It is to be noted that the maximum amount of the water to be passed allowed by the system may be set as the amount of the water to be passed during the low-temperature start, but there is not any special restriction on the value of the amount of the water to be passed as long as the temperature fluctuation among the cells can be suppressed. Needless to say, not only the amount of the water to be passed but also the flow speed and the pressure may be controlled. Furthermore, it is not intended that the amount of the water to be passed is limited to a constant amount, and the amount may appropriately be changed in accordance with the temperature, the output voltage or the like of the fuel cell 40.

When the passing water control of the cooling water is started using a passing water control map MP1 for the low-temperature start, the control device 160 starts the warm-up of the fuel cell 40 by effectively using self heat generation accompanying power generation (step S4). Specifically, the fuel cell 40 is operated (a low-efficiency operation) in an oxidizing gas deficiency state to efficiently warm up the fuel cell 40. The control device 160 advances to step S5 to grasp the temperature Ts of the fuel cell 40 detected by the temperature sensor s6 and to judge whether or not the temperature has reached a set target temperature To. In a case where it is judged that the temperature has not reached the target temperature To yet, the control device returns to the step S3 to repeatedly execute the above series of processing. On the other hand, in a case where it is judged that the temperature has reached the target temperature To, the warm-up operation is ended to start the usual operation.

As described above, according to the present embodiment, the amount of the cooling water to be passed during the low-temperature start is set to an amount larger than the amount of the cooling water to be passed during the usual start. Therefore, even when the warm-up operation is performed, the temperature fluctuation among the cells can be suppressed, and homogeneous temperature rise characteristics can be obtained in the whole fuel cell. It is to be noted that needless to say, the time is not limited to the start time as long as an operation (a low-temperature operation) is performed at a low temperature.

### B. Modification

(1) In the above embodiment, the bypass channel 240 which allows the cooling water to bypass the radiator 230 is provided, and the flow rate ratio between the flow rate of the cooling water to be passed through the radiator 230 and the bypass flow rate of the cooling water allowed to bypass the radiator 230 is controlled to regulate the heat radiation of the radiator 230. However, the driving of a cooling fan may be controlled to regulate the heat radiation of the radiator 230.

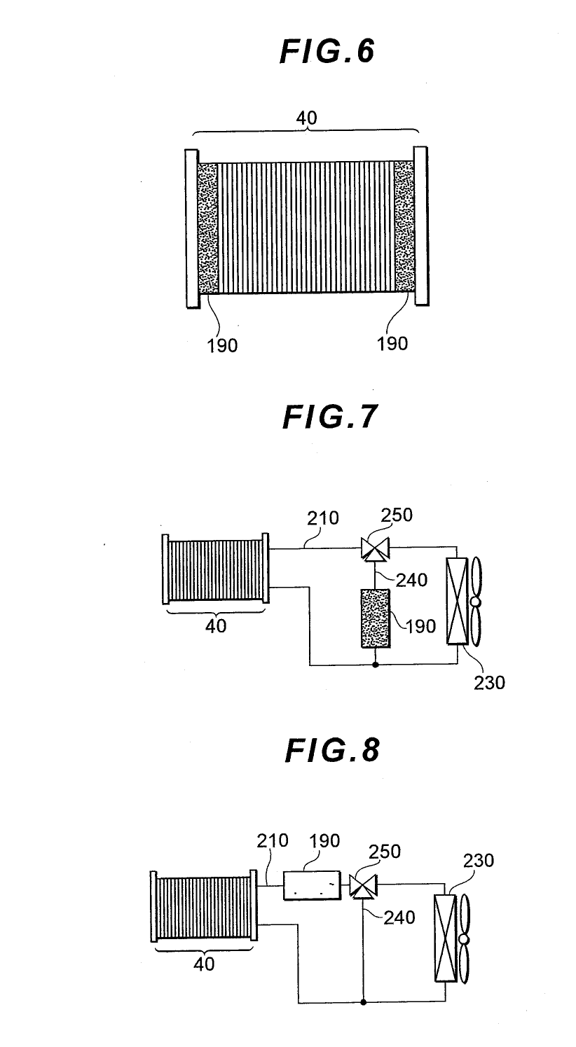

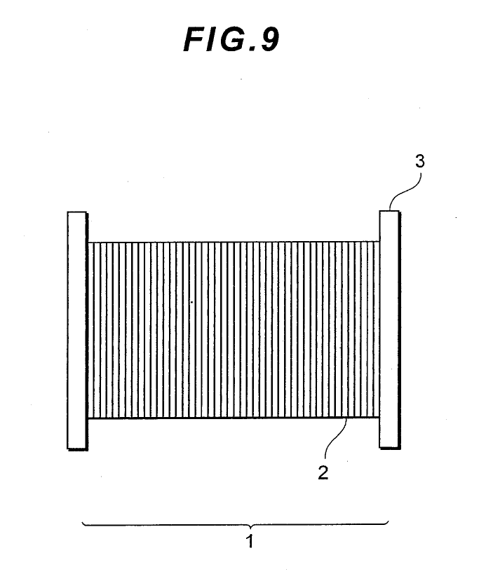

(2) Moreover, in the above present embodiment, the amount of the water to be passed is controlled to control the temperature fluctuation among the cells. However, in addition to (or instead of) this control, the temperature of the cooling water or the like may be controlled to realize homogeneous temperature rise in a short time. Specifically, as shown in FIG. 6, heaters 190 for heating may be installed on the ends of the fuel cell 40 to control the temperatures of the end cells, thereby preventing the delay of the temperature rise of the end cells. Moreover, a bypass channel 240 (see FIG. 7) may be installed or a heater 190 may be installed along a cooling water circulation path 210 (see FIG. 8) to control the temperature of the cooling water, thereby suppressing the temperature fluctuation among the cells. It is to be noted that when the heater 190 is installed along the bypass channel 240, pressure loss during usual cooling (at a time when the temperature of the cooling water is not controlled) can be decreased.

1. A temperature control system for a fuel cell which circulates a heat transfer medium through the fuel cell to control the temperature of the fuel cell,
the system comprising:
a warm-up control device for warming up the fuel cell by low-efficiency power generation during a low-temperature operation; and
a circulation control device for circulating, through the fuel cell, the heat transfer medium having a flow rate larger than that for a normal operation during a low-temperature operation.

2. The temperature control system for the fuel cell according to claim 1, further comprising:
a judgment device for detecting the temperature concerning the fuel cell to judge based on the detection result whether to start the system at the low temperature or to normally start the system during the starting of the system,
wherein the circulation control device circulates, through the fuel cell, the heat transfer medium having a flow rate larger than that for the usual start during the low-temperature start.

3. The temperature control system for the fuel cell according to claim 1,
wherein the ends of the fuel cell are provided with heaters which heat the ends of the fuel cell during the low-temperature operation.

4. The temperature control system for the fuel cell according to claim 1, wherein a channel of the heat transfer medium is provided with a heater which heats the heat transfer medium during the low-temperature operation.

5. The temperature control system for the fuel cell according to claim 1, further comprising:
a radiator which performs heat exchange between the heat transfer medium and outside air; and
a control device for regulating the heat radiation of the radiator during the low-temperature operation.

6. The temperature control system for the fuel cell according to claim 1, wherein the flow rate of the heat transfer medium to be circulated during the low-temperature operation is the maximum flow rate allowed by the system.

7. The temperature control system for the fuel cell according to claim 3, further comprising:
a temperature control device for controlling the temperatures of the heaters which heat the ends during the low-temperature operation to suppress a temperature fluctuation among cells.

8. The temperature control system for the fuel cell according to claim 7,
wherein end plates are provided on both ends of the fuel cell, and the ends of the fuel cell include cells positioned in the vicinity of the end plates.
